(19) United States
(12) Patent Application Publication
(10) Pub. No.: US 2009/0094171 A1
(43) Pub. Date: Apr. 9, 2009

(54) SYSTEM AND METHOD FOR MAXIMIZING AFTER-TAX INCOME USING SPLIT METHOD CHARITABLE REMAINDER TRUSTS

(76) Inventor: Benson L. Schaub, Phoenix, AZ (US)

Correspondence Address: Kunzler & McKenzie, 8 EAST BROADWAY, SUITE 600, SALT LAKE CITY, UT, 84111, US

(21) Appl. No.: 12/332,180

(22) Filed: Dec. 10, 2008

Related U.S. Application Data
(63) Continuation-in-part of application No. 11/158,681, filed on Jun. 22, 2005.

(51) Int. Cl. G06Q 40/00; G06N 5/02

(52) U.S. Cl. 705/36 T; 705/40; 706/46

(57) ABSTRACT

A system and method are disclosed for maximizing after-tax income from charitable remainder trusts, An evaluation service establishes a first charitable remainder trust (CRT-1) that generates ordinary income from fixed income investments and a second charitable remainder trust CRT-2 that generates growth income from equity investments. The evaluation service further identifies a qualifying charitable organization. The evaluation service integrates an income beneficiary risk tolerance t_{b}, a qualifying charitable organization risk tolerance t_{c}, and a grantor weight w to generate an integrated risk tolerance tᵢ. Each risk tolerance specifies a ratio of assets that are allocated to generating ordinary income from fixed income investments and the grantor weight is a number between zero and one that increases as the income beneficiary's risk tolerance is favored. The evaluation service further distributes tᵢ of a grantor's assets to the CRT-1 and 1−tᵢ of the grantor's assets to the CRT-2.

### CROSS-REFERENCES TO RELATED APPLICATIONS

This application is a continuation-in-part of and claims priority to U.S. patent application Ser. No. 11/158,681, filed on Jun. 22, 2005 and entitled “SYSTEM AND METHOD FOR MAXIMIZING AFTER-TAX INCOME USING SPLIT METHOD CHARITABLE REMAINDER TRUSTS”

### BACKGROUND OF THE INVENTION

1. Field of the Invention

The present invention relates to Charitable Remainder Trusts and more particularly to maximizing after-tax income using Charitable Remainder Trusts.

2. Description of the Related Art

Charitable Remainder Trusts (CRT) complying with Section 664 of the Internal Revenue Code often generate both ordinary income and growth income. A portion of income is distributed to one or more income beneficiaries and taxed depending on the type of income. For example, the ordinary income may be taxed at an income beneficiary's marginal tax rate while the growth income is taxed at a lower capital gains rate. Unfortunately, the income beneficiary may be unable to benefit from the lower tax rate of the growth income if the distribution entirely includes the ordinary income.

### SUMMARY OF THE INVENTION

From the foregoing discussion, there is a need for a system and method that maximizes CRT after-tax income. Beneficially, such a system and method would distribute a grantor's assets to accommodate risk tolerances of income beneficiaries and qualifying charitable organizations while maximizing after tax income.

The present invention has been developed in response to the present state of the art, and in particular, in response to the problems and needs in the art that have not yet been fully solved by currently available CRT funding methods. Accordingly, the present invention has been developed to provide a system and method for maximizing after-tax income that overcome many or all of the above-discussed shortcomings in the art.

A system of the present invention is also presented to maximize after-tax income. The system, in one embodiment, includes a first CRT (CRT-1), a second CRT (CRT-2), a qualifying charitable organization, and an evaluation service. The CRT-1 generates ordinary income from fixed income investments. A first percentage of a value of the income investments is distributed to an income beneficiary and distributions are taxed under 26 United States Code (U.S.C.) section 664.

The CRT-2 generates growth income from equity investments. A second percentage of a value of the equity investments is distributed to the income beneficiary and distributions are taxed under 26 U.S.C. section 664. The qualifying charitable organization that is designated as a remainderman of the CRT-1 and the CRT-2.

The evaluation service integrates an income beneficiary risk tolerance t_{b}, a qualifying charitable organization risk tolerance t_{c}, and a grantor weight w to generate an integrated risk tolerance tᵢ. Each risk tolerance specifies a ratio of assets that are allocated to generating ordinary income from fixed income investments and the grantor weight is a number between zero and one that increases as the income beneficiary's risk tolerance is favored. The evaluation service further distributes tᵢ of a grantor's assets to the CRT-1 and 1−tᵢ of the grantor's assets to the CRT-2.

A method of the present invention is presented for maximizing after-tax income. In one embodiment, the method includes establishing a CRT-1, establishing a CRT-2, identifying a qualifying charitable organization, integrated risk tolerances, and distributing a grantor's assets.

An evaluation service establishes a CRT-1 that generates ordinary income from fixed income investments. A first percentage of a value of the income investments is distributed to an income beneficiary and distributions are taxed under 26 U.S.C. section 664.

The evaluation service establishes a CRT-2 that generates growth income from equity investments. A second percentage of a value of the equity investments is distributed to the income beneficiary and distributions are taxed under 26 U.S.C. section 664. The evaluation service further identifies a qualifying charitable organization. The qualifying charitable organization is designated as a remainderman of the CRT-1 and the CRT-2.

The evaluation service integrates an income beneficiary risk tolerance t_{b}, a qualifying charitable organization risk tolerance t_{c}, and a grantor weight w to generate an integrated risk tolerance tᵢ. Each risk tolerance specifies a ratio of assets that are allocated to generating ordinary income from fixed income investments and the grantor weight is a number between zero and one that increases as the income beneficiary's risk tolerance is favored. The evaluation service further distributes tᵢ of a grantor's assets to the CRT-1 and 1−tᵢ of the grantor's assets to the CRT-2.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram depicting one embodiment of a split investment combination of a Fixed Income Investment Charitable Remainder Trust (CRT-1) and an Equity Investment Charitable Remainder Trust (CRT-2);

FIG. 2 is a schematic block diagram depicting one embodiment of distribution system for trust income from the CRT-1 and CRT-2 during the lifetime of the grantor;

FIG. 3 is a schematic block diagram depicting one embodiment of a distribution system for trust assets following the death of the grantor;

FIG. 4 is a schematic flow chart diagram depicting one embodiment of a method for maximizing income to the grantor and income beneficiaries through use of a plurality of charitable remainder trusts and, upon the death of the grantor, passing the remainder of the estate to a charity;

FIG. 5 is a schematic block diagram depicting one embodiment of an apparatus configured to evaluate the distribution of assets between the CRT-1 and the CRT-2; and

FIG. 6 is a schematic flow chart diagram depicting one embodiment of distributing assets of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, specific details are provided. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Individuals typically wish to minimize taxes on their assets and income, thus maximizing the amount available for themselves, their beneficiaries, and charitable giving. Various classes of trusts, including CRTs, provide an effective tax planning vehicle.

Under section 664 of the Internal Revenue Code, the source of income generation within a CRT determines how distributions will be treated in the hands of the trust's income beneficiary. Thus, distributions from a CRT generating ordinary income through fixed-income vehicles, such as CDs, government securities, mortgages, etc., will be taxed as ordinary income in the hands of the income beneficiary. Distributions from a CRT generating income through long term growth in equity investments will be taxed as capital gains in the hands of the income beneficiary. In a balanced or mixed investment CRT, all distributions will be taxed as ordinary income until the distributions have exhausted the portion of the trust income generated by fixed income investments. Only then will the beneficiaries receive the benefit of the substantially lower capital gains rate on the distributions that they receive, even if equity investments generate a substantial portion of the trust income or growth. Under currently regulations, neither the grantor nor the beneficiaries can exercise control over the percentage of distributions taxed as fixed income and as capital gains. If the fixed income investments supply income sufficient to cover the distributions, the grantor and other beneficiaries may never enjoy the benefit of the lower capital gains tax rate. The current invention provides a system and method for administering trusts so as to give the grantor greater control over the taxing of distributions. The drawings depict one embodiment of the system and method.

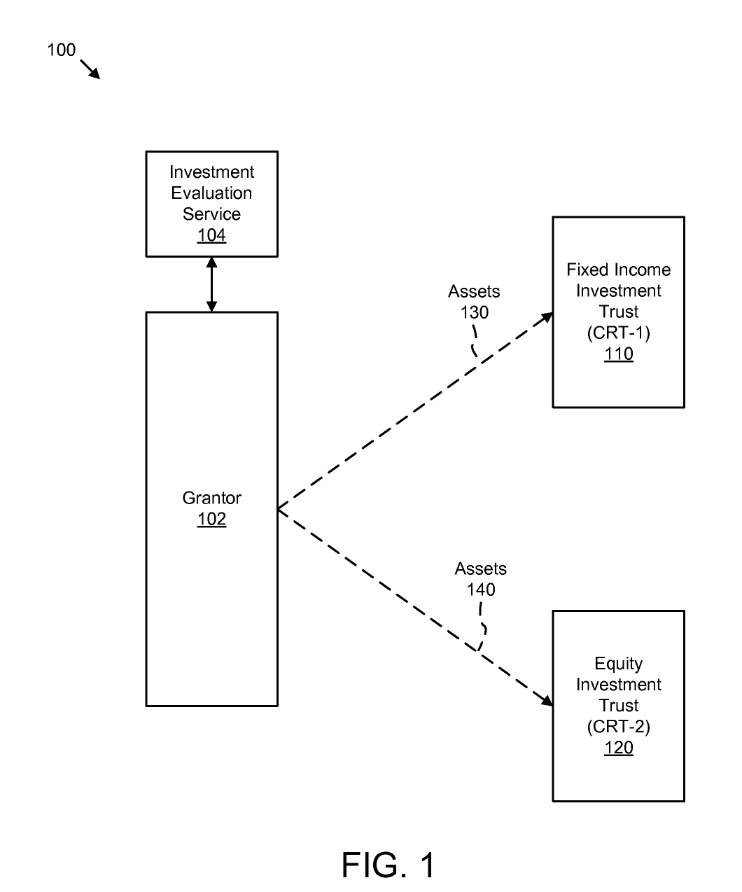

FIG. 1 is a schematic block diagram depicting one embodiment of split investment combination 100 of a Fixed Income Investment Trust (“CRT-1”) 110 and an Equity Investment Trust (“CRT-2”) 120. As depicted, the combination 100 includes a grantor 102, an investment evaluation service 104, a CRT-1 110, a CRT 2 120, assets 130 and assets 140. The grantor 102 is understood to include any investment advisor, financial service, trustee, or other representative of the grantor.

The investment evaluation service 104 analyzes the relative income and risk potential of fixed income investments and equity investments and combines these with information regarding the risk/benefit preferences of the grantor 102. The investment evaluation service 104 advises the grantor 102 regarding the distribution of assets 130, 140. The grantor 102 distributes assets 130 and 140 between the trusts according to preference. In so doing, the grantor 102 balances the lower risk, fixed earning rate and higher tax rate of the ordinary income investment type CRT-1 110 with the higher risk, variable growth rate, and lower tax rate of the equity or capital gain investment type CRT-2 120. Because the two income type generation mechanisms are separated into two CRTs, rather than combined in one, the grantor 102 may be sure that at least a portion of distributions will enjoy the lower capital gains tax rate.

In a further embodiment, the grantor 102 establishes CRT-1 110 and CRT-2 120 as charitable remainder annuity trusts (CRAT), wherein distributions are calculated as a percentage of the original value of the trust assets 130, 140. In a further embodiment, the grantor 102 establishes CRT-1 110 and CRT-2 120 as charitable remainder unitrusts (CRUT) wherein distributions are calculated as a percentage of the annual value of the trust assets. Alternatively, the grantor 102 may establish one of CRT-1 110 and CRT-2 120 as a CRAT and the other as a CRUT. In so doing, the grantor 102 considers the relative risk and earning capacity of fixed income and equity investments. For example, the grantor 102 may establish the lower risk and fixed earning fixed income trust as a CRAT, yielding fixed distribution income while gradually increasing the asset value of the trust and establish the higher risk, variable earning equity investment trust as a CRUT, which pays out higher income distributions as the trust corpus increases, but preserves the trust corpus by paying lower income distributions if the corpus diminishes. In one embodiment, one of the CRTs is an insurance trust funded with a wealth replacement life insurance policy.

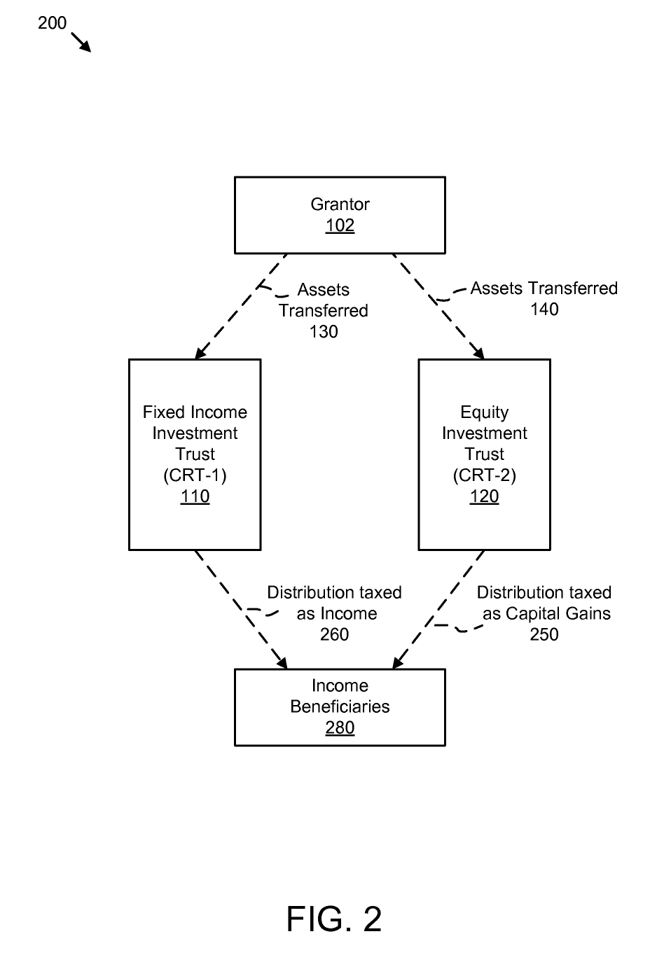

FIG. 2 is a schematic block diagram depicting one embodiment of a distribution system 200 for trust income from the CRT-1 110 and the CRT-2 120 during the lifetime of the grantor 102. As depicted, the distribution 200 comprises the grantor 102, the CRT-1 110, the CRT-2 120, assets transferred 130 and 140, an income distribution 260, a capital gains distribution 250, and one or more income beneficiaries 280. The description of FIG. 2 refers to elements of FIG. 1, like numbers referring to like elements.

The grantor 102 funds the CRT-1 110 and the CRT-2 120 with asset transfers 130. The CRT-1 110 and CRT-2 120 holds the income producing assets that are transferred 130. Distributions 260 from the CRT-1 110 to the income beneficiaries 280 are taxed as ordinary income. Distributions 250 from the CRT-2 120 to the income beneficiaries 280 are taxed as long-term capital gains income. In one embodiment, the grantor 102 is also an income beneficiary 280.

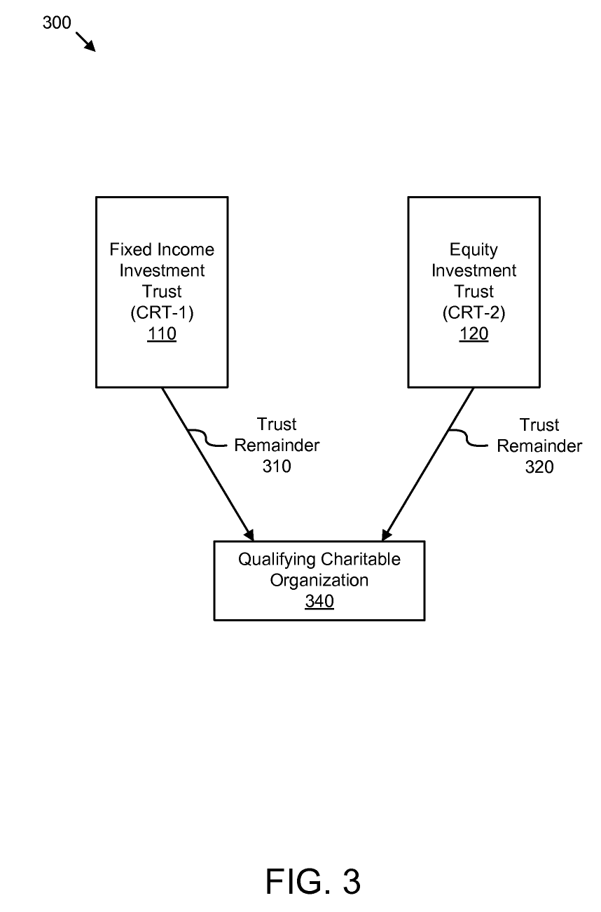

FIG. 3 is a schematic block diagram depicting one embodiment of a distribution system 300 for trust assets following the death of the grantor 102 or other triggering event. The description of FIG. 3 refers to elements of FIGS. 1-2, like numbers referring to like elements. As depicted, the distribution system 300 comprises a CRT-1 110, a CRT-2 120, a CRT-1 trust remainder 310, a CRT-2 trust remainder 320, and a qualifying charitable organization 340.

Upon the death of the grantor 102, or another triggering event, the assets remaining in the CRT-1 110 and the CRT-2 120 flow tax-free to the qualifying charitable organization 340, which may be a family foundation or other qualifying charitable organization.

The grantor 102 may establish a period of years or other triggering event for termination of the CRT-1 110 and CRT-2 120, and the ensuing payout of trust remainders 310 and 320. In a further embodiment, the trust remainders 310 and 320 may remain in the CRT-1 110 and CRT-2 120 to be used for qualifying charitable purposes.

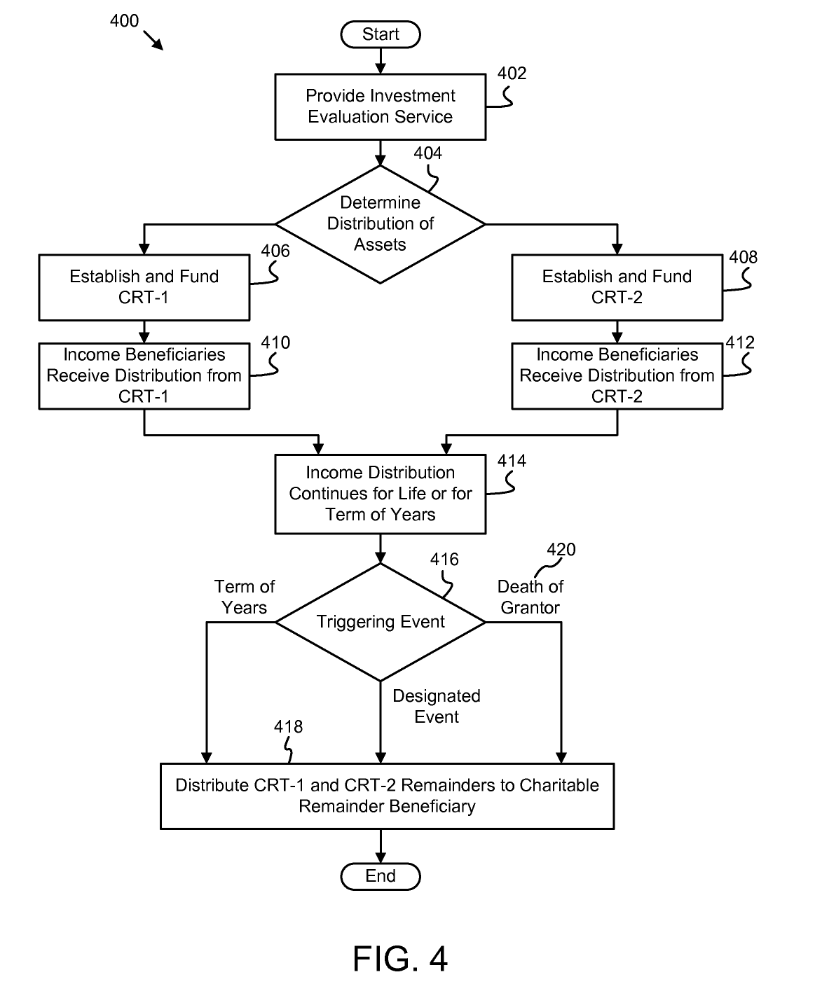

FIG. 4 is a schematic flow chart diagram depicting one embodiment of a method 400 for maximizing income to the grantor 102 through use of a plurality of charitable remainder trusts 110, 120, and, upon the death of the grantor 102, passing the remainder of the estate to a charity. The description of the method 400 refers to elements of FIGS. 1-3, like numbers referring to like elements. As depicted, the method 400 includes establishing 418 a qualifying charitable organization 340, providing 402 an investment evaluation service, determining 404 the distribution of assets 130 and 140, establishing and funding 406 a CRT-1 110, establishing and funding 408 a CRT-2 120, receiving 410 income beneficiary distributions 260 from the CRT-1 110, receiving 412 income beneficiary distributions 260 from the CRT-2-120, income distribution continues 414 for life or for terms of years, the triggering event 416, distributing 418 the CRT-1 remainder 310 to the qualifying charitable organization 340, and the CRT-2 remainder 320 to the qualifying charitable organization 340, the death 420 of the grantor 102.

Considerations such as risk, growth rate, and tax rate may influence the distribution of assets 130 and 140 between the CRT-1 110 and the CRT-2 120. Risk and growth considerations may also influence the establishment of the trusts as CRUTs, CRATs, or a combination of both.

The grantor 102 may designate a family foundation or other qualifying charitable organization 380 to receive the trust remainders 310 and 320. In a further embodiment, an event other than the death 420 of the grantor 102, such as a term of years, may trigger distribution of the trust remainders 310 and 320. Alternatively, the triggering event may convert CRT-1 110 and CRT-2 120 to qualifying charitable organizations 380 or qualifying charitable purposes rather than dissolving the CRTs 110 and 120 and distributing the remainders 310 and 320.

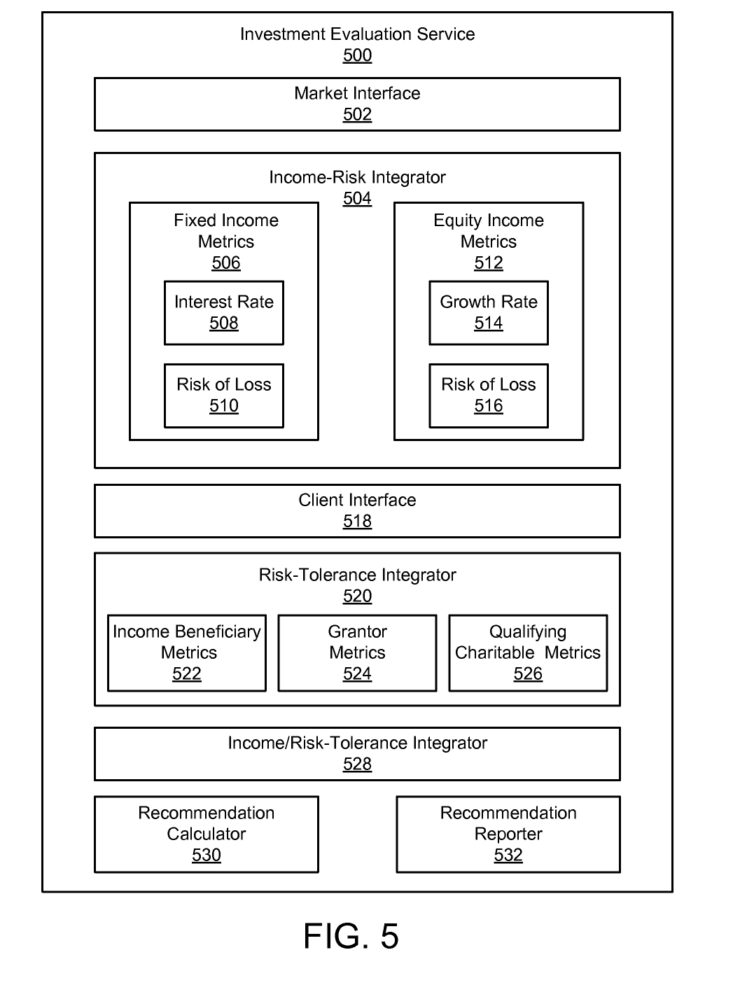

FIG. 5 is a schematic block diagram depicting one embodiment of an investment evaluation service apparatus 500 configured to evaluate the distribution of assets between the CRT-1 110 and the CRT-2 120. As depicted, the apparatus 500 comprises a market interface 502, an income risk integrator 504, fixed income metrics 506, including an interest rate 508 and a risk of loss 510, equity investment metrics 512, including a growth rate 514 and a risk of loss 516, a client interface 518, a risk-tolerance integrator 520, including income beneficiary metrics 522, grantor metrics 524, and charitable remainder beneficiary metrics 526, and income-risk/risk-tolerance integrator 528, and recommendation calculator 530, and a recommendation reporter 532.

In various embodiments, the apparatus 500 may comprise a computer readable storage medium storing one or more computer readable programs that are executed on a processor of computer hardware. The computer readable programs may include the market interface 502, income risk integrator 504, fixed income metrics 506, interest rate 508, risk of loss 510, equity investment metrics 512, growth rate 514, risk of loss 516, client interface 518, risk-tolerance integrator 520, income beneficiary metrics 522, grantor metrics 524, charitable remainder beneficiary metrics 526, income-risk/risk-tolerance integrator 528, recommendation calculator 530, and a recommendation reporter 532. The apparatus 500 may further comprises computer displays, input devices, printers, networks, and the like.

In the depicted embodiment, the market interface 502 supplies investment data to the income-risk integrator 504. The data may include income potential such as interest rates 508 for fixed income investments and growth rates 514 for equity investments. The data may also include the risk of loss 510 and 516, as established by a range of analysts and reporting agencies for each of the investments. The income-risk integrator 504 analyzes and integrates the data 506 and 512 for the fixed income and equity investments, respectively, and calculates a current risk benefit indicator for each class of investment. The income-risk integrator 504 then passes the indicators to the income/risk-tolerance integrator 528.

The client interface 518 receives income beneficiary metrics 522, grantor metrics 524, and qualifying charitable organization metrics 526 from the relevant entities. The income beneficiary metrics 522 may include an income beneficiary risk tolerance t_{b}. The qualifying charitable organization metrics 526 may include a qualifying charitable organization risk tolerance t_{c}. The grantor metrics 524 may include a grantor weight w.

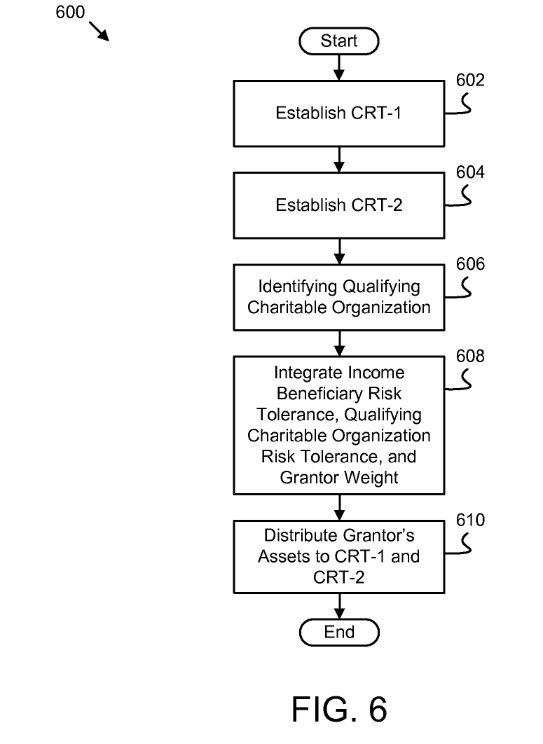

The client interface 518 passes the information to the risk-tolerance integrator 520. The risk-tolerance integrator 520 analyzes the metrics 522, 524, and 526, and calculates an integrated risk tolerance indicator tᵢ as will be described hereafter in FIG. 6. The client interface 518 passes the integrated risk tolerance indicator tᵢ to the risk-tolerance integrator 520.

The income/risk-tolerance integrator 528 analyzes the investment indicator calculated by the income-risk integrator 504 and the risk tolerance indicator tᵢ calculated by the risk-tolerance integrator 520 and calculates an integrated income/risk-tolerance function. In one embodiment the integrated income/risk-tolerance function is that CRT-1 is funded with tᵢ times the total funding of CRT-1 and CRT-2 and that CRT-2 is funded with (1−tᵢ) times the total funding of CRT-1 and CRT-2. The recommendation calculator 530 employs the integrated income-risk/tolerance function to calculate a recommended distribution of assets between the CRT-1 and the CRT-2. The recommendation calculator 530 passes the recommended distribution to the recommendation reporter 532, which passes the recommendation to the client interface 518.

FIG. 6 is a schematic flow chart diagram depicting one embodiment of a method 600 distributing assets of the present invention. The method 600 substantially includes the steps to carry out the functions presented above with respect to the operation of the described apparatus 500 of FIG. 5. In one embodiment, the method 600 is implemented with a computer readable storage medium comprising a computer readable program stored on a tangible storage device. The computer readable storage medium may be integrated into a computing system, wherein the computer readable program executed by the computing system performs the method 600.

The evaluation service apparatus 500 establishes 602 the CRT-1 110 as described for step 406 of FIG. 4. The CRT-1 110 generates ordinary income from fixed income investments. A first percentage of a value of the income investments is distributed to the income beneficiary 280 and distributions are taxed under 26 U.S.C. section 664.

The evaluation service apparatus 500 further establishes 604 the CRT-2 120 that generates growth income from equity investments as described for step 408 of FIG. 4. A second percentage of a value of the equity investments is distributed to the income beneficiary 280 and distributions are taxed under 26 U.S.C. section 664. In one embodiment, the first percentage is equal to the second percentage. In an alternate embodiment, the first percentage is greater than the second percentage.

The evaluation service apparatus 500 further identifies 606 the qualifying charitable organization 340. The qualifying charitable organization 340 may be organized to satisfy the requirements of 26 U.S.C. section 664. Alternately, the qualifying charitable organization 340 may be selected by the grantor 102 and identified 606 as satisfying the requirements of 26 U.S.C. section 664. The qualifying charitable organization 340 is designated as a remainderman of the CRT-1 and the CRT-2.

The evaluation service apparatus 500 integrates 608 an income beneficiary risk tolerance t_{b}, a qualifying charitable organization risk tolerance t_{c}, and a grantor weight w to generate an integrated risk tolerance tᵢ. Each risk tolerance specifies a ratio of assets that are allocated to generating ordinary income from fixed income investments out of total assets. For example, if the income beneficiary 280 has a risk tolerance specifying that 25% of assets should be in fixed income assets, the income beneficiary risk tolerance t_{b} is 0.25.

The grantor weight is a number between zero and one that increases as the income beneficiary's risk tolerance is favored. For example, if the granter 102 wishes to weight the integrated risk tolerance tᵢ entirely in favor of the income beneficiary 280, the weight w is set to one. Similarly, a weight of 0.5 indicates that the grantor 102 is indifferent between favoring the income beneficiaries 280 and the qualifying charitable organization 340. In one embodiment, the integrated risk tolerance tᵢ is calculated using Equation 1.

tᵢ=wt_{b}+(1−w)t_{c}. Equation 1

In an alternate embodiment, the integrated risk tolerance tᵢ may be calculated to adjust for the different investment time frames of the income beneficiary 280 and the qualifying charitable organization 340. For example, the income beneficiary 280 is more exposed to short term market fluctuations than the qualifying charitable organization 340, so that the income beneficiary 280 should be more favored than is reflected in the grantor weight w. In a certain embodiment, the grantor weight w is adjusted using Equation 2, where y is the adjusted weight and a is a constant. In one embodiment, a is 0.95.

y=√w Equation 2

The integrated risk tolerance tᵢ is then calculated using Equation 3.

tᵢ=yt_{b}+(1−y)t_{c}. Equation 3

In one embodiment, the integrated risk tolerance tᵢ is adjusted so that an expected return of the CRT-1 110 is equal to the first percentage. The evaluation service apparatus 500 further distributes 610 tᵢ of a grantor's assets to the CRT-1 110 and 1−tᵢ of the grantor's assets to the CRT-2 120 as described in steps 406 and 408 of FIG. 4. For example, if the grantor 102 funds CRT-1 110 and CRT-2 120 with a total of $1,000,000, the CRT-1 receives tᵢX$1,000,000 and the CRT-2 120 receives (1−tᵢ)X$1,000,000.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for maximizing after-tax income on distributions from a: Charitable Remainder Trusts (CRT), the system comprising:
a first class of CRT (CRT-1) generating ordinary income from fixed income investments, wherein a first percentage of a value of the income investments is distributed to an income beneficiary and distributions are taxed under 26 United States Code (U.S.C.) section 664;
a second class of CRT (CRT-2) generating growth income from equity investments, wherein a second percentage of a value of the equity investments is distributed to the income beneficiary and distributions are taxed under 26 U.S.C. section 664;
a qualifying charitable organization designated as a remainderman of the CRT-1 and CRT-2;
an evaluation service comprising executable code stored on a storage device, executed by a processor, and configured to integrate an income beneficiary risk tolerance t_{b}, a qualifying charitable organization risk tolerance t_{c}, and a grantor weight w to generate an integrated risk tolerance tᵢ, wherein each risk tolerance specifies a ratio of assets that are allocated to generating ordinary income from fixed income investments and the grantor weight is a number between zero and one that increases as the income beneficiary's risk tolerance t_{b} is favored;
the evaluation service further distributing tᵢ of a grantor's assets to the CRT-1 and 1−tᵢ of the grantor's assets to the CRT-2.

2. The system of claim 1, wherein the integrated risk tolerance tᵢ is calculated as tᵢ=wt_{b}+(1−w)t_{c}.

3. The system of claim 1, wherein the integrated risk tolerance tᵢ is calculated as tᵢ=yt_{b}+(1−y)t_{c} where y=a√w.

4. The system of claim 1, wherein the integrated risk tolerance is adjusted so that an expected return of the CRT-1 is equal to the first percentage.

5. The system of claim 1, wherein the first percentage is equal to the second percentage.

6. The system of claim 1, wherein the qualifying charitable organization is a family foundation.

7. The system of claim 1, wherein the CRT-1 and CRT-2 become active charitable vehicles following an event otherwise triggering dissolution of the CRT-1 and the CRT-2 and distribution of the remainder to a qualifying charitable organization.

8. The system of claim 1, wherein the CRT-1 comprises an individual trust and the CRT-2 comprises an individual trust.

9. The system of claim 1, wherein the CRT-1 and CRT-2 are selected from the group consisting of a charitable remainder unitrust and a charitable remainder annuity trust.

10. The system of claim 1, wherein at least one CRT is an insurance trust funded with a wealth replacement life insurance policy.

11. A method performed by a executable code stored on a computer readable storage medium for maximizing after-tax income on distributions from Charitable Remainder Trusts (CRT), the method comprising:
establishing a first class of CRT (CRT-1) generating ordinary income from fixed income investments, wherein a first percentage of a value of the income investments is distributed to an income beneficiary and distributions are taxed under 26 United States Code (U.S.C.) section 664;
establishing a second class of CRT (CRT-2) generating growth from equity investments, wherein a second percentage of a value of the equity investments is distributed to the income beneficiary and distributions are taxed under 26 U.S.C. section 664;
identifying a qualifying charitable organization designated as a remainderman of the CRT-1 and CRT-2;
integrating an income beneficiary risk tolerance t_{b}, a qualifying charitable organization risk tolerance t_{c}, and a grantor weight w to generate an integrated risk tolerance tᵢ, wherein each risk tolerance specifies a ratio of assets that are allocated to generating ordinary income from fixed income investments and the grantor weight is a number between zero and one that increases as the income beneficiary's risk tolerance t_{b} is favored;
distributing tᵢ of a grantor's assets to the CRT-1 and 1−tᵢ of the grantor's assets to the CRT-2.

12. The method of claim 11, wherein the integrated risk tolerance tᵢ is calculated as tᵢ=wt_{b}+(1−w)t_{c}.

13. The method of claim 11, wherein the integrated risk tolerance tᵢ is calculated as tᵢ=yt_{b}+(1−y)t_{c} where y=a√w.

14. The method of claim 11, wherein the integrated risk tolerance is adjusted so that an expected return of the CRT-1 is equal to the first percentage.

15. The method of claim 11, wherein the first percentage is equal to the second percentage.

16. The method of claim 11, wherein the qualifying charitable organization is a family foundation.

17. The method of claim 11, wherein the CRT-1 and CRT-2 become active charitable vehicles following an event otherwise triggering dissolution of the CRT-1 and the CRT-2 and distribution of the remainder to a qualifying charitable organization.

18. The method of claim 11, wherein the CRT-1 comprises an individual trust and the CRT-2 comprises an individual trust.

19. The method of claim 11, wherein the CRT-1 and CRT-2 are selected from the group consisting of a charitable remainder unitrust and a charitable remainder annuity trust.

20. The method of claim 11, wherein at least one CRT is an insurance trust funded with a wealth replacement life insurance policy.
